(19) United States
(12) Patent Application Publication
(10) Pub. No.: US 2006/0262077 A1
(43) Pub. Date: Nov. 23, 2006

(54) LIQUID CRYSTAL DISPLAY DEVICE

(76) Inventor: Kimitaka Terasaka, Ishikawa-gun (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/383,594

(22) Filed: May 16, 2006

(30) Foreign Application Priority Data
May 18, 2005 (JP) 2005-145461

(51) Int. Cl. G09G 3/36

(52) U.S. Cl. 345/102

(57) ABSTRACT

A liquid crystal display device includes a liquid crystal display panel having a display area, light sources which illuminate the display area, and a control section having a display panel control circuit which drives the liquid crystal display panel and a backlight control circuit which drives the light sources. The control section is configured to have a partition mode in which the display area is partitioned into a letterbox region and a video display region and to individually control the luminance of a first group of the light sources that mainly illuminate the letterbox region and the luminance of a second group of the light sources that mainly illuminate the video display region, in the partition mode.

### CROSS-REFERENCE TO RELATED APPLICATIONS

This application is based upon and claims the benefit of priority from prior Japanese Patent Application No. 2005-145461, filed May 18, 2005, the entire contents of which are incorporated herein by reference.

### BACKGROUND OF THE INVENTION

1. Field of the Invention

The present invention relates to a liquid crystal display device applied to a liquid crystal display panel of an optically compensated birefringence (OCB) mode.

2. Description of the Related Art

A flat-panel display device represented by a liquid crystal display device is widely utilized as a display device for a computer, a car navigation system, or a television receiver and the like.

Generally, the liquid crystal display device comprises a liquid crystal display panel that includes a matrix array of liquid crystal pixels, and a display panel control circuit that controls the display panel. The liquid crystal display panel has a structure in which a liquid crystal layer is held between an array substrate and a counter substrate.

The array substrate includes a plurality of pixel electrodes arrayed substantially in a matrix, a plurality of gate lines arranged along the rows of pixel electrodes, a plurality of source lines arranged along the columns of pixel electrodes, and a plurality of switching elements arranged near intersections between the gate lines and the source lines. Each switching element is made of a thin-film transistor (TFT), for example, and is tuned on to apply the potential of a corresponding source line to a corresponding pixel electrode when a corresponding gate line has been driven. On the counter substrate, a common electrode is provided to face the pixel electrodes arrayed on the array substrate. Each pair of the pixel electrodes and common electrode serves as a pixel together with a pixel region of the liquid crystal layer, and controls the alignment of liquid crystal molecules in the pixel region by an electric field between the pixel electrode and the common electrode. The display panel control circuit includes a gate driver for driving the gate lines, a source driver for driving the source lines, and a controller for controlling operation timings of the gate driver and source driver, for example.

In the case where the liquid crystal display device is used for a TV receiver that principally displays a moving image, a liquid crystal display panel of an OCB mode, in which liquid crystal molecules exhibit a good response characteristic, has begun to be employed (refer to Jpn. Pat. Appln. KOKAI Publication No. 2002-202491). In the liquid crystal display panel, liquid crystal molecules are set to a splay alignment before supply of power by alignment layers which have been rubbed on the pixel electrode and the common electrode. The liquid crystal display panel begins a display operation after the liquid crystal molecules have been transferred from the splay alignment to a bend alignment by a relatively strong electric field applied in an initializing process which is performed upon supply of power.

A reason why the liquid crystal molecules are set to the splay alignment before supply of power is that the splay alignment is more stable than the bend alignment in terms of energy in a no-voltage-applied state of a liquid crystal drive voltage. Even after the liquid crystal molecules have been transferred to the bend alignment, the bend alignment of the molecules tends to be inverse-transferred to the splay alignment if a no-voltage-applied state or a voltage-applied state of a voltage not higher than a level at which the energy of splay alignment is balanced with the energy of bend alignment, continues for a long time. The viewing angle characteristic of the splay alignment significantly differs from that of the bend alignment. Thus, a normal display is not attained in the splay alignment.

In a conventional driving method that prevents the inverse-transfer from the bend alignment to the splay alignment, a high voltage is applied to the liquid crystal molecules in a part of one frame period for display of a single-frame image, for example. This high voltage corresponds to a pixel voltage for a black display in a liquid crystal display panel, which is a normally-white type, so this driving method is called “black insertion driving.”

In the meantime, in a conventional television set having an AI function, backlight control, i.e., luminance setting of light that illuminates a whole display area has been carried out so as to adapt brightness of the whole display area to a scene. Thus, for example in a mode where the display area is partitioned into an invalid display part for a black flat display and a valid display part for a video display, there has been a problem that the contrast of the valid display part to the invalid display part are lowered.

### BRIEF SUMMARY OF THE INVENTION

It is an object of the present invention to provide a liquid crystal display device which can improve a contrast of a valid display part to an invalid display part to obtain a high quality image.

According to the present invention, there is provided a liquid crystal display device which comprises a liquid crystal display panel having a display area, a plurality of light sources which illuminate the display area, and a control section which drives the liquid crystal display panel and the light sources, wherein the control section is configured to have a partition mode in which the display area is partitioned into an invalid display part and a valid display part and to individually control the luminance of a first group of the light sources that mainly illuminate the invalid display part and the luminance of a second group of the light sources that mainly illuminate the valid display part, in the partition mode.

With the liquid crystal display device, the luminance of the first group of the light sources that illuminates the invalid display part can be set to be lower than the luminance of the second group of the light sources that illuminate the valid display part for a video display in the partition mode, in order to eliminate so called black fading that occurs as a whitish black display in the invalid display part, which is a letterbox display region of the display area. Therefore, a high quality image is obtainable as a result of improvement in the contrast of the valid display part to the invalid display part.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing the circuit configuration of a liquid crystal display device according to a first embodiment of the present invention;

FIG. 2 is a view showing the configuration of a backlight shown in FIG. 1;

FIG. 3 is a view showing an example of a partition-mode display of a liquid crystal display panel shown in FIG. 1;

FIG. 4 is a view showing an operation of a backlight control circuit shown in FIG. 1;

FIG. 5 is a view showing the configuration of a backlight provided at a liquid crystal display device according to a second embodiment of the present invention; and

FIG. 6 is a view showing an example of a partition-mode display of a liquid crystal display panel shown in FIG. 5.

### DETAILED DESCRIPTION OF THE INVENTION

A liquid crystal display device according to a first embodiment of the present invention will be described with reference to the accompanying drawings.

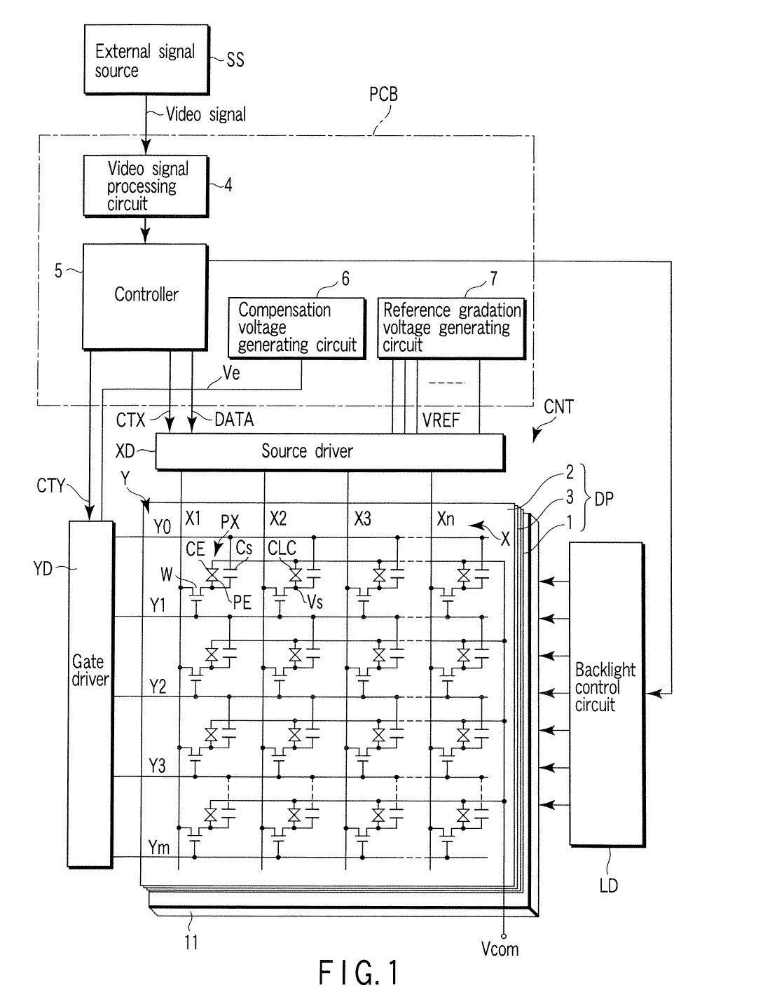

FIG. 1 schematically shows the circuit configuration of the liquid crystal display device 11 according to the first embodiment. The liquid crystal display device 11 comprises a liquid crystal display panel DP, a display panel control circuit CNT connected to the display panel DP, a backlight 11 for illuminating the display panel DP, and a backlight control circuit LD for driving and controlling the backlight 11. The liquid crystal display panel DP has a structure in which a liquid crystal layer 3 is held between an array substrate 1 and a counter substrate 2. The liquid crystal layer 3 includes a liquid crystal material whose liquid crystal molecules are transferred in advance from a splay alignment to a bend alignment to attain a normally-white display operation in an OCB mode and are prevented from being inverse-transferred from the bend alignment to the splay alignment by a black display voltage periodically applied thereto. The display panel control circuit CNT applies a liquid crystal drive voltage from the array substrate 1 and the counter substrate 2 to the liquid crystal layer 3 to control transmittance of the liquid crystal display panel DP. The splay alignment can be transferred to the bend alignment by applying a relatively large electric field to the liquid crystal molecules in a predetermined initializing process which is performed by the display panel control circuit CNT upon supply of power.

The array substrate 1 includes a plurality of pixel electrodes PE arrayed substantially in a matrix on a transparent insulating substrate such as a glass plate, a plurality of gate lines Y (Y0 to Ym) arranged along the rows of pixel electrodes PE, a plurality of source lines X (X1 to Xn) arranged along the columns of pixel electrodes PE, and a plurality of pixel switching elements W which are arranged near intersections between the gate lines Y and the source lines X. Each of the pixel switching elements W turns on between a corresponding source line X and a corresponding pixel electrode PE when a corresponding gate line Y is driven. Further, each pixel switching element W is made, for example, of a thin-film transistor, a gate of the thin-film transistor is connected to the gate line Y, and a source-drain path is connected between the source line X and the pixel electrode PE.

The counter substrate 2 includes a color filter formed on a transparent insulating substrate such as a glass plate, and a common electrode CE formed on the color filter and facing the pixel electrodes PE. The pixel electrodes PE and the common electrode CE are made of a transparent electrode material such as ITO, and are covered with alignment layers rubbed in parallel to each other. Each pair of the electrodes PE and common electrode CE serves as a pixel PX together with a pixel region of the liquid crystal layer 3, in which the alignment of liquid crystal molecules is controlled by an electric field between the pixel electrode PE and the common electrode CE.

The pixels PX have liquid crystal capacitances CLC provided between the pixel electrodes PE and the common electrode CE and connected to one ends of storage capacitances Cs. Each of the storage capacitances Cs is obtained by capacitive coupling between the pixel electrode PE of one pixel PX and a gate line Y which is located next to this pixel PX on one side and controls the pixel switching elements for the pixels PX of a previous row, and has a sufficiently large capacitance with respect to a parasitic capacitance of the pixel switching element W. In addition, although there are dummy pixels located outside the matrix array of pixels PX which serve as a display area, these dummy pixels are omitted in FIG. 1. The dummy pixels are wired in the same manner as that for the pixels PX in the display area in order to establish equivalent conditions with respect to the parasitic capacitance or the like. A gate line Y0 is provided for such dummy pixels.

The display panel control circuit CNT includes a video signal processing circuit 4 for receiving a video signal including pixel data items DATA for the pixels PX and input from an external signal source SS every one-frame period (vertical scan period) and processing the video signal to convert resolution, gradation and the like, a gate driver YD for sequentially driving the gate lines Y0 to Ym to turn on the switching elements W in units of one row, a source driver XD for converting the pixel data items DATA which are supplied in series for the pixels PX of each row as a conversion result of the video signal processing circuit 4 to pixel voltages Vs and outputting the pixel voltages Vs to the source lines X1 to Xn while the switching elements W of each row are kept conductive by driving a corresponding gate line Y, and a controller 5 for controlling operation timings or the like of the gate driver YD and the source driver XD to be suitable for the pixel data items DATA for the pixels PX of each row. Each pixel voltage Vs is a voltage applied to a corresponding pixel electrode PE with a common voltage Vcom of the common electrode CE used as a reference. The polarity of the pixel voltage Vs is inverted with respect to the common voltage Vcom so as to carry out frame inversion driving and line inversion driving, for example.

Each of the gate driver YD and the source driver XD is provided as integrated circuit (IC) chips mounted on flexible wiring sheets arranged along an outer edge of the array substrate 1, for example. On the other hand, the video signal processing circuit 4 and the controller 5 are provided on an external printed circuit board PCB. The controller 5 produces a control signal CTY for a control of sequentially driving the gate lines Y, and a control signal CTX for a control of assigning the pixel data items DATA for the pixels PX of each row to the source lines X and specifying an output polarity, for example. The control signal CTY is supplied from the controller 5 to the gate driver YD, and the control signal CTX is supplied from the controller 5 to the source driver XD together with the pixel data items DATA for the pixels PX of each row.

The display panel control circuit CNT further includes a compensation voltage generating circuit 6 for generating a compensation voltage Ve used to compensate for fluctuation of the pixel voltages Vs caused by the pixel switching elements W for the pixels PX of one row and a reference gradation voltage generating circuit 7 for generating a predetermined number of gradation reference voltages VREF used to convert the pixel data items DATA to the pixel voltages Vs. When the pixel switching elements W for the pixels PX of the row are made nonconductive, the compensation voltage Ve is applied via the gate driver YD to a previous gate line Y which is located on one side next to the gate line Y connected to the pixel switching elements W.

The gate driver YD is controlled by the control signal CTY to sequentially select the gate lines Y1 to Ym in one frame period and supply to a selected one of the gate lines Y1 to Ym an on-voltage by which the pixel switching elements W for the pixels PX of one row are made conductive for one horizontal scan period. The video signal processing circuit 4 outputs a conversion result of pixel data items DATA for the pixels PX of one row every one horizontal scan period. The source driver XD converts the pixel data items DATA to pixel voltages Vs, respectively, by referring to the predetermined number of gradation reference voltages VREF supplied from the reference gradation voltage generating circuit 7 described above, and outputs the pixel voltages Vs to the source lines X1 to Xn in parallel.

For example, when the gate line Y1 is driven by the ON voltage from the gate driver YD to turn on all of the pixel switching elements W connected to the gate line Y1, the pixel voltages Vs on the source lines X1 to Xn are supplied to the corresponding pixel electrodes PE and the ends of the corresponding storage capacitances Cs via the pixel switching elements W, respectively. The compensation voltage Ve from the compensation voltage generating circuit 6 is output to the previous gate line Y0 next to the gate line Y1 by the gate driver YD. Immediately after all the pixel switching elements W connected to the gate line Y1 are kept conductive for one horizontal scan period, the gate driver YD outputs an off-voltage to the gate line Y1 to make the pixel switching elements W nonconductive. When these pixel switching elements W have been made nonconductive, the compensation voltage Ve serves to reduce the amount of charge pulled out from the pixel electrodes PE due to the parasitic capacitances of the pixel switching elements W and cancel substantial fluctuation of the pixel voltage Vs, i.e., a field-through voltage ΔVp.

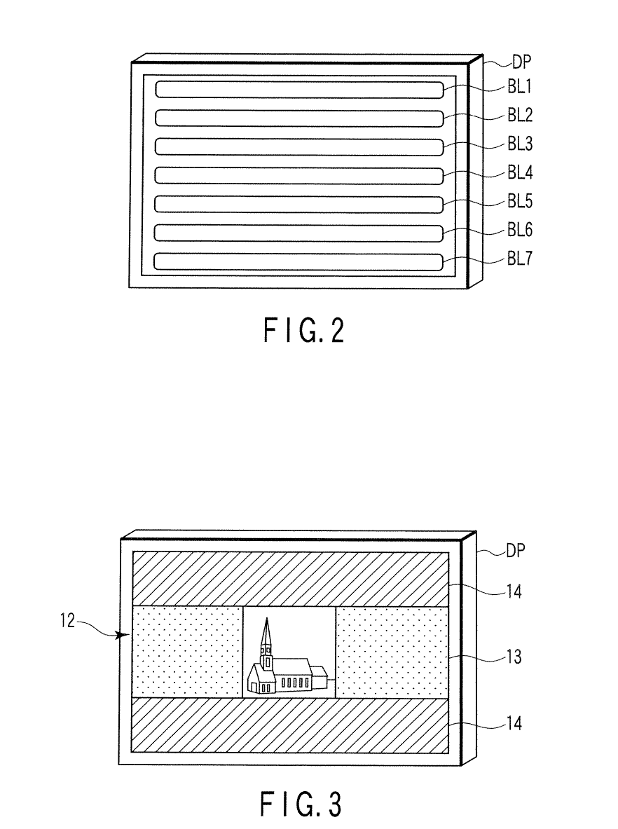

FIG. 2 shows a configuration of a backlight 11 shown in FIG. 1. The backlight 11 is composed, for example, of seven light sources BL1 to BL7 provided on a rear side of the liquid crystal display panel DP. Each of the light sources BL1 to BL7 is made of a cold-cathode fluorescent tube (CCFL), for example. The backlight control circuit LD is configured to independently control the light sources BL1 to BL7 to have luminance suitable for the video signal from the controller 5.

FIG. 3 shows an example of a partition-mode display of the liquid crystal display panel DP. In a partition mode, the display area 12 of this liquid crystal display panel DP is partitioned into a video display region 13 (valid display part) and upper and lower letterbox display regions (invalid display part) 14 located above and below the video display region 13. The upper and lower letterbox display regions 14 are used to display images having an average gradation level of 0%, and the video display region 13 is used to display an image having an average gradation level more than 0%, for example of 50%. In this example, the upper letterbox region 14 is illuminated by the light sources BL1 and BL2, the video display region 13 is illuminated by the light sources BL3, BL4 and BL5, and the lower letterbox region 14 is illuminated by the light sources BL6 and BL7.

Before explaining backlight control for the partition-mode display performed in the first embodiment, conventional control will be described here.

Conventionally, the backlight 11 for the whole display area 12 has been controlled to have luminance adapted to a scene in the video display region 13. When an increase in brightness is required for the scene in the video display region 13, the luminance of the backlight 11 is adjusted to increase the brightness of the whole display area 12. Thus, there has been a problem that the black display in the upper and lower letterbox regions 14 becomes whitish.

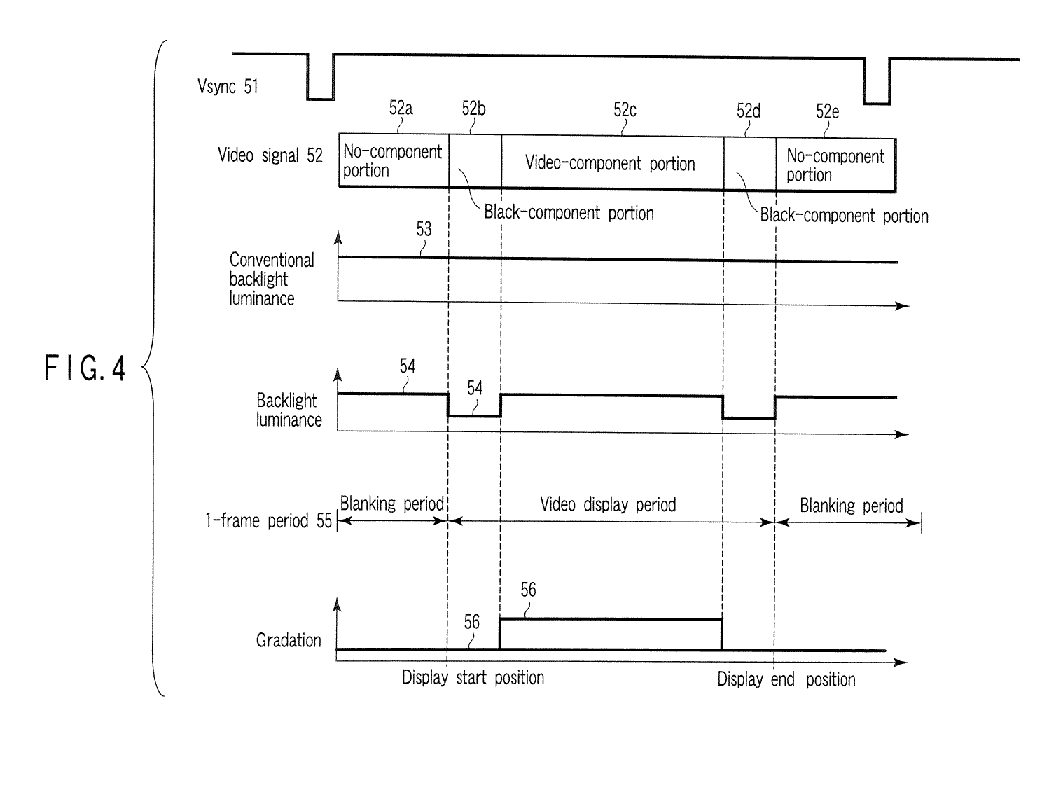

Backlight control in the first embodiment will be described with reference to FIG. 4.

First, assume that a video signal 52 has been input for one frame period 55 defined by a vertical sync signal (Vsync) 51 to obtain the partition-mode display shown in FIG. 3.

The video signal 52 is formed of a no-component portion 52a, a black-component portion 52b, a video-component portion 52c, a black-component portion 52d, and a no-component portion 52e, which are arranged in this order. In one frame period 55 defined by the vertical sync signal 51, the no-component portions 52a and 52e are received during the blanking periods, and the black-component portion 52b, the video-component portion 52c and the black-component portion 52d are received during the display period.

The black-component portion 52b, a video-component portion 52c, and the black-component portion 52d are represented by gradation levels of the pixel data items DATA for the pixels PX. The beginning of the black-component portion 52b is assigned to a display start point, and the end of the black-component portion 52d is assigned to a display end point.

Referring to FIG. 3, an image of the black-component portion 52b is displayed in the upper letterbox region 14, an image of the video-component portion 52c is displayed in the video display region 13, and an image of the black-component portion 52d is displayed in the lower letterbox region 14.

In the conventional control, the light sources BL1 to BL7 of the backlight 11 are set to have the same luminance levels 53 determined by the input video signal 52. As a result, there has been a problem that the black display in the upper and lower letterbox regions 14 becomes whitish, as described above.

Therefore, in the present embodiment, the backlight control circuit LD detects distribution of gradation levels of the pixel data items DATA in the video signal 52 from the controller 5, and individually controls the luminance of a first group of the light sources BL1 to BL7 that mainly illuminate the upper and lower letterbox regions 14 specified by a result of detection and the luminance of a second group of the light sources BL1 to BL7 that mainly illuminate the video display region 13 specified by the result of detection.

The light sources BL1 to BL7 of the backlight 11 are set to have individual luminance levels 54 determined by the video signal 52. More specifically, the layouts of the upper letterbox region 14, the video display region 13, and the lower letterbox region 14 which display images of the black-component portion 52b, the video-component portion 52c, and the black-component portion 52d are confirmed based on distribution 56 of the gradation levels of the pixel data items DATA in the video signal 52. When it is detected that the upper letterbox region 14 is mainly illuminated by the light sources BL1 and BL2, the video display region 13 is mainly illuminated by the light sources BL3 to BL5, and the lower letterbox region 14 is mainly illuminated by the light sources BL6 and BL7, the light sources BL1, BL2, BL6 and BL7 are specified as the first group, and the light sources BL3 to BL5 are specified as the second group. As a result, the backlight control circuit LD sets the luminance of the light sources BL1, BL2, BL6 and BL7 to be lower than that of the light sources BL3 to BL5.

In the first embodiment described above, the luminance of the light sources BL1, BL2, BL6 and BL7 that illuminates the invalid display part, i.e., the upper and lower letterbox regions 14 is set to be lower than the luminance of the light sources BL3 to BL5 that illuminate the valid display part, i.e., the video display region 13 for a video display in the partition mode, in order to eliminate so called black fading that occurs as a whitish black display in the invalid display part. Therefore, a high quality image is obtainable as a result of improvement in the contrast of the valid display part to the invalid display part.

A liquid crystal display device according to a second embodiment of the present invention will be described hereinafter. This liquid crystal display device is configured in the same manner as that of the first embodiment, except the following points described below. The backlight 11 and backlight control circuit LD differ from those of the first embodiment.

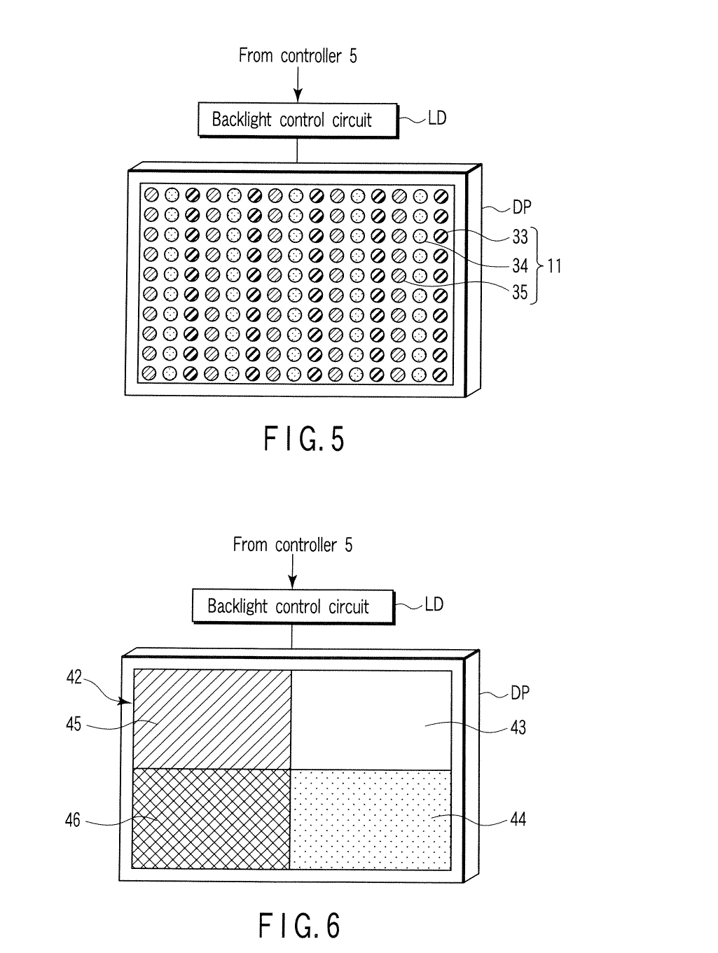

FIG. 5 schematically shows the configuration of a backlight 11 provided in this liquid crystal display device. FIG. 6 shows an example of the partition-mode display of the liquid crystal display panel DP shown in FIG. 5. The backlight 11 has three-color light emitting diodes (hereinafter, referred to as LEDs), such as blue LEDs 33, green LEDs 34 and red LEDs 35 which are provided on a rear side of the liquid crystal display panel DP as shown in FIG. 5. These LEDs 33, 34 and 35 serve as light sources that illuminate a display area 42 of the liquid crystal display panel DP.

The first embodiment has been effective for a video signal representing images to be displayed in the upper letterbox region 14, video display region 13 and lower letterbox region 14, which extend in parallel along the cold-cathode fluorescent tubes (CCFLs) serving as the light sources BL1 to BL7 of the backlight 11 which is located directly below the display area 12.

In contrast, the three-color LEDs 33, 34 and 35 are used in the second embodiment. In a partition mode, as shown in FIG. 6, the display area 42 of this liquid crystal display panel DP is partitioned into white, green, and red display regions (valid display part) 43, 44 and 45 and a black display region (invalid display part) 46, for example. The black display region 46 is used to display an image having an average gradation level of 0%, and the white, green, and red display regions 43, 44 and 45 are used to display images having an average gradation level more than 0%.

Each of the white display region 43, the green display region 44, the red display region 45 and the black display region 46 faces a quarter of the number of the LEDs 33, 34 and 35 regularly arranged as shown in FIG. 5. To obtain a high quality image in the partition mode, the backlight control circuit LD divides the LEDs 33, 34 and 35 into four groups that mainly illuminate the white display region 43, the green display region 44, the red display region 45 and the black display region 46, respectively, and individually controls the groups to have optimal luminance levels.

First, assume that a video signal 52 has been input for one frame period defined by a vertical sync signal (Vsync) 51 to obtain the partition-mode display shown in FIG. 6.

The video signal 52 is formed of a no-component portion, a white-component portion, a green-component portion, a red-component portion, a black-component portion, and a no-component portion. The white-component portion, the green-component portion, the red-component portion, and the black-component portion are represented by gradation levels of pixel data items DATA for the pixels PX.

Referring to FIG. 6, an image of the white-component portion is displayed in the white display region 43, an image of the green-component portion is displayed in the green display region 44, an image of the red-component portion is displayed in the red display region 45, and an image of the black-component portion is displayed in the black display portion 46.

The backlight control circuit LD detects distribution of gradation levels of the pixel data items DATA in the video signal 52 from the controller 5, and individually controls the luminance of a first group of the LEDs 33, 34 and 35 that mainly illuminate the white display region 43, the luminance of a second group of the LEDs 33, 34 and 35 that mainly illuminate the green display region 44, the luminance of a third group of the LEDs 33, 34 and 35 that mainly illuminate the red display region 45, the luminance of a fourth group of the LEDs 33, 34 and 35 that mainly illuminate the black display region 46. More specifically, the LEDs 33, 34 and 35 of the first group are set to have luminance levels optimized for a white display, the LEDs 33, 34 and 35 of the second group are set to have luminance levels optimized for a green display, the LEDs 33, 34 and 35 of the third group are set to have luminance levels optimized for a red display, and the LEDs 33, 34 and 35 of the fourth group are set to have luminance levels optimized for a black display.

The layouts of the display regions 43, 44 and 45 are confirmed based on the distribution of the gradation levels of the pixel data items DATA in the video signal 52. Further, the backlight control circuit LD sets the luminance of the first to third groups of the LEDs 33, 34 and 35 to be lower than that of the fourth group of the LEDs 33, 34 and 35.

In this manner, more contrastive image quality can be achieved by controlling luminance levels of the color LEDs 33, 34, and 35 serving as light sources of the backlight 11.

As described above, without being limited to the cold-cathode fluorescent tubes (CCFLs) used in the first embodiment, effective illumination control can be made in the second embodiment which uses light emitting diodes (LEDs) as the backlight 11.

According to the second embodiment, in the partition mode, the luminance of the first to third groups of the LEDs 33, 34 and 35 that mainly illuminate the white, green and red display regions 43, 44 and 45, is set to be lower than that of the fourth group of the LEDs 33, 34 and 35 that mainly illuminate the black display region 46, in order to eliminate black fading that occurs as a whitish black display in the invalid display part. Therefore, a high quality image is obtainable as a result of improvement in the contrast of the valid display part to the invalid display part.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a liquid crystal display panel having a display area;
a plurality of light sources which illuminate the display area; and
a control section which drives the liquid crystal display panel and the light sources;
wherein the control section is configured to have a partition mode in which the display area is partitioned into an invalid display part and a valid display part and to individually control the luminance of a first group of the light sources that mainly illuminate the invalid display part and the luminance of a second group of the light sources that mainly illuminate the valid display part, in the partition mode.

2. The liquid crystal display device according to claim 1, wherein the control section is configured to detect distribution of gradation levels for pixels in a video signal and specify the first group of the light sources that mainly illuminate the invalid display part and the second group of the light sources that mainly illuminate the valid display part, based on a result of detection.

3. The liquid crystal display device according to claim 2, wherein the plurality of light sources are cold-cathode fluorescent tubes which are selectively assigned to one of the invalid display part and the valid display part.

4. The liquid crystal display device according to claim 2, wherein the plurality of light sources light-emitting diodes which are selectively assigned to one of the invalid display part and the valid display part.

5. The liquid crystal display device according to claim 3, wherein the control section is configured to set the luminance of the cold-cathode fluorescent tubes assigned to the invalid display part to be lower than that of the cold-cathode fluorescent tubes assigned to the valid display part.

6. The liquid crystal display device according to claim 4, wherein the control section is configured to set the luminance of the light-emitting diodes assigned to the invalid display part to be lower than that of the light-emitting diodes assigned to the valid display part.

7. The liquid crystal display device according to claim 2, wherein the control section is configured to set the luminance of the first group of the light sources that mainly illuminate the invalid display part to be lower than that of the second group of the light sources that mainly illuminate the valid display part.
